(19) United States
(12) Patent Application Publication
(10) Pub. No.: US 2013/0075481 A1
(43) Pub. Date: Mar. 28, 2013

(54) Security and Inventory Management Tag and System Therefor

(71) Applicants: Jeffrey A. Raymond, Leominster, MA (US); William J. Cooper, Natick, MA (US)

(72) Inventors: Jeffrey A. Raymond, Leominster, MA (US); William J. Cooper, Natick, MA (US)

(73) Assignee: AVERY DENNISON CORPORATION, Pasadena, CA (US)

(21) Appl. No.: 13/699,031

(22) PCT Filed: Jun. 14, 2011
(86) PCT No.: PCT/US11/40269

§ 371 Date: Nov. 20, 2012

Related U.S. Application Data
(60) Provisional application No. 61/354,419, filed on Jun. 14, 2010.

(51) Int. Cl. G06K 19/077

(52) U.S. Cl. CPC G06K 19/07758
USPC 235/492

(57) ABSTRACT

The present invention is directed to a security and inventory management device for use with a consumer article and more particularly to an apparel item. The security and inventory management device is removably secured to the consumer article and includes a radio frequency device enclosed within the housing.

### CROSS-REFERENCE TO RELATED APPLICATION

The present application claims the benefit of U.S. Provisional Ser. No. 61/354,419 filed Jun. 14, 2010, which is incorporated herein by reference in its entirety.

### FIELD OF THE INVENTION

The present invention relates to security and inventory management devices. More particularly, the present invention is directed to a rigid tag structure which includes a locking mechanism to secure the tag to an article of commerce. The rigid tag includes a radio frequency device encased within the housing of the tag which can be used for inventory management as well as for security situations.

### BACKGROUND OF THE INVENTION

Shoplifting is a prevalent concern in the marketplace, and there are many security devices that are used in connection with providing article security to address this concern. Many security devices require an alarm triggering system. Such systems typically require the device to be deactivated by a store clerk when a consumer properly purchases an item. If an individual attempts to steal an item, the security device remains active and will trigger a detection system at the entrance or exit of the store. This alarm will alert the staff that an individual is attempting to steal an item. The alarm, besides signaling a thief, may also signal that the device was not properly deactivated by clerk upon proper purchase by a consumer. Such devices commonly are called EAS devices and may use a resonating device which unfortunately can be easily defeated by experienced individuals.

It is often desired by retail stores to be able to inventory their stock of goods. For efficiency reasons, it is desired that a single device be able to provide inventory management, security functions that are not easily defeatable, and devices that serve as a visible deterrent to reduce the amount of shoplifting. It is also desired that such a device that is capable of providing a plurality of functions be cost efficient.

There remains a need in the marketplace for a financially reasonable device that can provide all of the previously mentioned functions.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention is directed to a security device that uses a radio frequency element that operates in one of the UHF, HF or LF frequencies. The radio frequency or RF device is preferably provided in an inlay configuration in which an antenna with an integrated circuit connected thereto is provided on a first substrate, such as PET and may then be sandwiched or laminated to further protect the RF device.

In one exemplary embodiment of the presently described invention, a security and inventory management tag is described and includes a housing with a cavity formed therein. The housing has a base portion and a top portion, first and second longitudinally extending side edges and a first end and a second end. The second end is tapered from the first end and the first end has a bulbous element extending upwardly from the top portion and having an opening centrally disposed within the bulbous element. A radio frequency device is disposed within the cavity, the radio frequency device including an inlay having a substrate with an antenna and an integrated circuit coupled to the antenna. A locking mechanism is placed in the first end and extends vertically into the bulbous element and upwardly to the opening.

In a still further exemplary embodiment of the presently described invention, a security and inventory management system that includes a consumer article and a security and inventory management tag that has a housing with a cavity formed therein. The housing has a base portion and a top portion, first and second longitudinally extending side edges, a first end and a second end with the second end tapered from the first end. The first end having a bulbous element extending upwardly from the top portion and having an opening centrally disposed within the bulbous element. The system further includes a radio frequency device disposed within the cavity. The radio frequency device (RFID) has an inlay with a substrate having an antenna and an integrated circuit coupled to the antenna thereon. A locking mechanism is placed in the first end and extends vertically into the bulbous element and upwardly to the opening. The security and inventory management tag is removably connected to the consumer article by the locking mechanism. By encasing the RFID device in a housing, the RFID device is protected from tampering by a thief who wishes to deactivate the RFID device in order to prevent detection.

In a yet still further exemplary embodiment of the presently described invention, a security and inventory management device for use with apparel items is described and includes a transparent housing with a cavity formed therein. The housing has a base portion and a top portion, first and second longitudinally extending side edges that slope upwardly and inwardly from the base portion toward a central area of the top portion, a first end and a second end, with the first end having an edge that is generally curvilinear. The second end tapered from the first end. The first end having a bulbous element extending upwardly from the top portion and having an opening centrally disposed within the bulbous element. The base portion has a cylindrical aperture extending upwardly from the base portion and disposed substantially beneath the bulbous element. The security and inventory management tag includes a radio frequency device disposed within the cavity. The radio frequency device includes an inlay having a substrate with an antenna and an integrated circuit coupled to the antenna. The antenna and integrated circuit are laminated in the substrate and operating in either a UHF, HF, or LF range.

The security and inventory management device of the presently described embodiment further include a locking mechanism that is placed in the first end and extends vertically into the bulbous element and upwardly to the opening of the bulbous opening and disposed at least partially in the cylindrical aperture of the base portion and a pin disposed at least partially through the opening the bulbous element.

The security and inventory management device may be clear, transparent, translucent, colored or may have a combination of the foregoing schemes and may also be provided with advertising indicia on a portion of the security and inventory management device that matches or otherwise corresponds to the consumer article to which it is attached.

The housing is preferably ultrasonically welded together, that is the top and bottom portions are welded along the first and second longitudinally extending sides. The first and second longitudinally extending sides taper from the first end to the second end and slope inwardly toward a central area of the top portion of the housing.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts an exploded view of an exemplary security and inventory management tag;

FIG. 2 provides an illustration of the completed security and inventory management tag of the presently described invention;

FIG. 3 illustrates the security and inventory management tag connected to a consumer article; and

FIG. 4 shows a security tag and inventory management with advertising indicia thereon.

### DETAILED DESCRIPTION OF THE INVENTION

The apparatuses and methods disclosed in this document are described in detail by way of examples and with reference to the figures. Unless otherwise specified, like numbers in the figures indicate references to the same, similar, or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific shapes, materials, techniques, arrangements, etc. are either related to a specific example presented or are merely a general description of such a shape, material, technique, arrangement, etc. Identifications of specific details or examples are not intended to be, and should not be, construed as mandatory or limiting unless specifically designated as such. Selected examples of apparatuses and methods are hereinafter disclosed and described in detail with reference made to FIGURES.

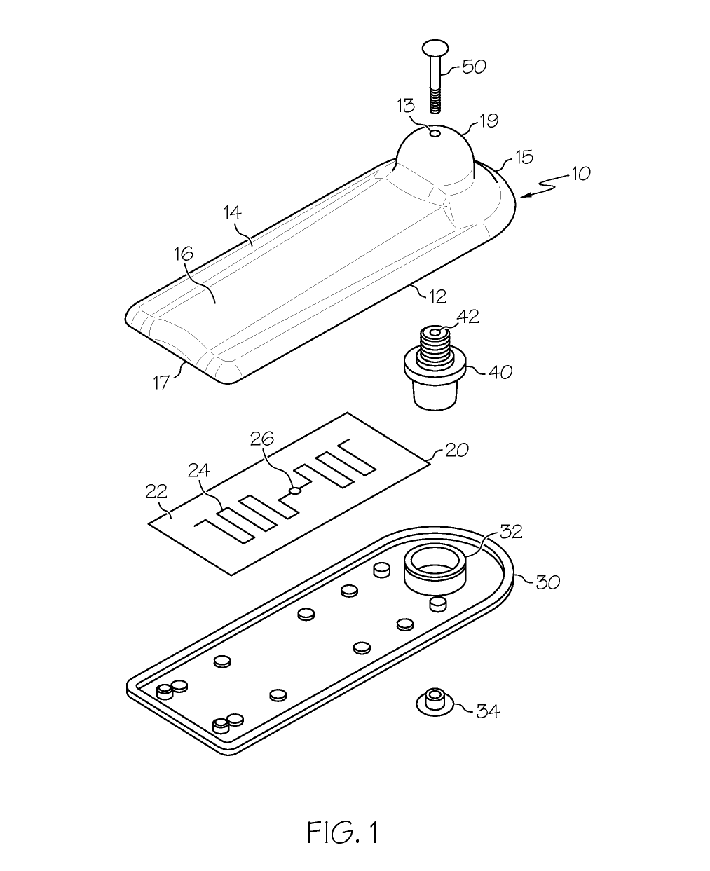

Reference is now directed to FIG. 1 of the presently described invention which shows the security and inventory management device generally in an exploded view. A security and inventory management device for use with apparel items is described and includes a housing with a cavity formed therein. The housing has a base portion 30 and a top portion 10, first and second longitudinally extending side edges 12, 14, respectively, that slope upwardly and inwardly from the base portion 30 toward a central area 16 of the top portion 10, a first end and a second end, 15, 17, respectively, with the first end 15 having an edge that is generally curvilinear. The second end 17 is tapered from the first end 15. The first end 15 having a bulbous element 19 extending upwardly from the top portion 10 and having an opening 13 centrally disposed within the bulbous element 19. The bulbous element 19 in one embodiment may be substantially flat.

The base portion 30 has a cylindrical aperture 32 extending upwardly from the base portion 30 and disposed substantially beneath the bulbous element 19. The security and inventory management tag includes a radio frequency device 20 disposed within the cavity in the housing. The radio frequency device 20 includes an inlay having a substrate 22 with an antenna 24 and an integrated circuit 26 coupled to the antenna 24. The antenna 24 and integrated circuit 26 are laminated in the substrate 22 and operate in the UHF (ultra high frequency) frequency, although other frequencies such as LF (low frequency) and HF (high frequency) are also possible.

The security and inventory management device of the presently described embodiment further include a locking mechanism 40 that is placed in the first end 15 and extends vertically into the bulbous element 19 and upwardly to the opening 13 of the bulbous opening 19 and disposed at least partially in the cylindrical aperture 32 of the base portion 30 and a pin 50 disposed at least partially through the opening 13 the bulbous element 19.

A pin 50 or other fastener device is inserted through the opening 13 in the bulbous portion 19, through the opening 42 in the locking device 40 and the cylindrical aperture 32 in the base portion 30 to connect with a locking element 34 so as to secure the security and inventory management device to a consumer article. The locking device 40 can be a mechanical locking device such as a ball and clutch or a magnetic device.

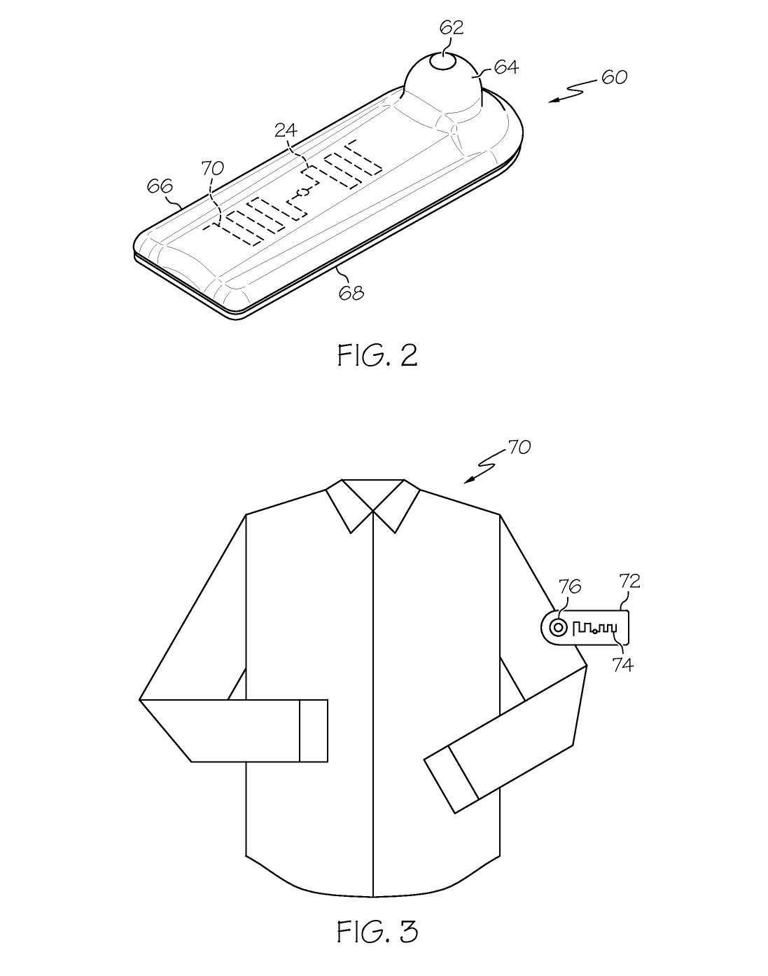

Turning now to FIG. 2, the security and inventory management tag 60 is shown in its assembled configuration with the pin 62 inserted though the opening in the bulbous element 64. The security and inventory management tag 60 may be ultrasonically welded together along its first and second longitudinally extending sides 66, 68, respectively. The sides 66 and 68 slope generally upwardly and inwardly toward a central area 70 on the top portion of the tag 60. As can be seen from FIG. 2, the tag slopes or tapers from the first end to the second end. In an exemplary embodiment, the RF element 24 is visible in the housing of the tag 60.

FIG. 3 provides an illustration of the security and inventory management tag 72 connected to a consumer item 70, such as an apparel item (e.g. shirt, blouse, pants, sweater, and the like). The security and inventory management tag 72 is fastened by a pin 76 and locking mechanism as previously described. The RF element 74 is visible as the housing of the element 72 is clear or substantially transparent or translucent.

In another embodiment, the device may be attached to another tag that may exhibit information about the apparel valuable to the consumer such as the price of the item. The device attached to a tag having information pertaining to an article may either be attached to apparel item piercing the item, or may be attached to an item via a SwifTach®.

In another embodiment the security and inventory management tag of the present invention may be attached to a lanyard which then may be attached to an article without the requirement that the security and inventory management device pierce the article. This is useful for more expensive items in which it would not be desirable to pierce the item, electronic articles, or other items in which it is difficult or impossible to pierce to the item to attach the security and inventory management device.

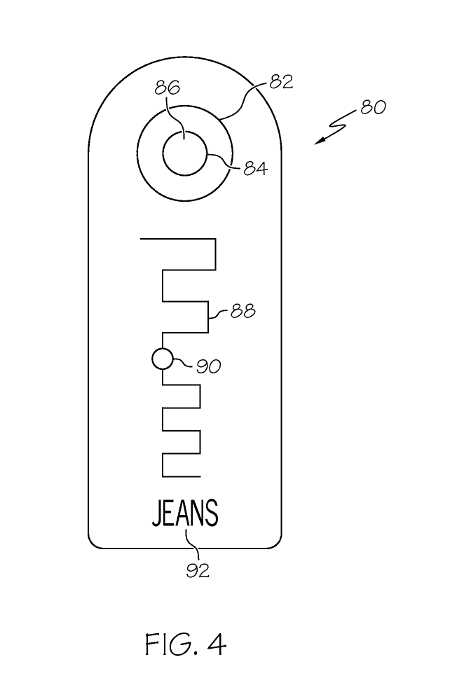

FIG. 4 shows a front elevation of a security and inventory management tag 80 having a pin 84 disposed in the bulbous area 82 with opening 86. The RF device shown in the security and inventory management tag 80 includes an antenna 88 and integrated circuit (IC) 90. The present invention contemplates that the IC may be directly attached to the antenna 88 or comparatively coupled to the antenna. In one embodiment, an interposer such as a strap attachment may be used to couple the IC 90 to the antenna 88. The device is for example a RFID inlay provided by Avery Dennison RFID Company of Clinton, S.C. In addition, the security and inventory management tag 80 is provided with advertising indicia 92 which may relate to the particular item to which the tag is associated with.

The present invention contemplates that the antenna may be of a variety of sizes and shapes.

The housing of the security and inventory management tag of the present invention may be manufactured from a relatively rigid material such as polycarbonate or ABS plastics or alternatively may be produced from recycled materials such as recycled PET.

The advertising indicia 90 may be molded into the security and inventory management tag assembly or may be imaged on top or on the bottom of the security and inventory management tag or may be provided by a pressure sensitive label that is applied to the security and inventory management tag. In addition to the housing being clear or substantially transparent or translucent, the tag may also be colored to stand out from the article or may be colored to better match the tag to the article to which it is attached or serve as part of the trade dress of a particular item or article of commerce.

The security and inventory management tag of the present invention has a dimension of roughly one inch wide by about two and a half or three inches in length. The first end has an elevation of about 0.4 inches and the second end has an elevation of about 0.15 inches. The bulbous element as shown in FIG. 1 has an elevation of about 0.5 inches when measured from the base of the top portion.

The bottom portion of the security and inventory management tag has a thickness of about 0.1 inch and the cylindrical aperture has an elevation when measured from the base of the bottom portion of about 0.1 inch. The cylindrical aperture and bulbous element have an opening of about 0.4 inches to accommodate the locking element.

The present invention also contemplates that the inlay be removed from the remainder of the device in order to provide a “dummy” like tag which serves as a deterrence to thieves.

The security and inventory management device of the present invention is also capable of being recycled when utilizing both materials for the housing and inlay that is capable of being recycled.

It will thus be seen according to the present invention a highly advantageous security and inventory management tag has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A security and inventory management tag, comprising;
a housing having a cavity formed therein, the housing having a base portion and a top portion, first and second longitudinally extending side edges, a first end and a second end, the second end tapered from the first end, the first end having a bulbous element extending upwardly from the top portion and having an opening centrally disposed within the bulbous element;
a radio frequency device disposed within the cavity, the radio frequency device including an inlay having a substrate with an antenna and an integrated circuit coupled to the antenna; and
a locking mechanism placed in the first end and extending vertically into the bulbous element and upwardly to the opening.

2. A tag as recited in claim 1, wherein the antenna and integrated circuit are laminated between two sheets of material defining the substrate.

3. A tag as recited in claim 1, wherein the housing is constructed from a group including recycled plastic material, polycarbonate, ABS plastic and combinations thereof.

4. A tag as recited in claim 1, wherein the housing is one of clear, transparent, translucent, colored or partially colored or combinations thereof.

5. A tag as recited in claim 1, wherein the radio frequency device is at least partially visible in the housing.

6. A tag as recited in claim 1, wherein the top portion is ultrasonically welded to the base portion.

7. A tag as recited in claim 6, wherein the top portion of the housing is tapered from the first end to the second end and the bottom portion of the housing is generally planar.

8. A tag as recited in claim 1, a locking pin sized and configured to fit at least partially through the opening in the bulbous element.

9. A tag as recited in claim 1, wherein the bottom portion includes a circular aperture disposed adjacent the first end and disposed beneath and in alignment with the bulbous elements.

10. A tag as recited in claim 1, wherein the first and second longitudinally extending sides slope upwardly and inwardly towards a central area of the top portion.

11. A tag as recited in claim 1, wherein the first end has an edge that is curvilinear and the second end has an edge that is generally perpendicular to each of the first and second longitudinally extending sides.

12. A security and inventory management system, comprising:
a consumer article;
a security and inventory management tag having a housing with a cavity formed therein, the housing having a base portion and a top portion, first and second longitudinally extending side edges, a first end and a second end, the second end tapered from the first end, the first end having a bulbous element extending upwardly from the top portion and having an opening centrally disposed within the bulbous element;
a radio frequency device disposed within the cavity, the radio frequency device including an inlay having a substrate with an antenna and an integrated circuit coupled to the antenna;
a locking mechanism placed in the first end and extending vertically into the bulbous element and upwardly to the opening; and
the security and inventory management tag is removably connected to the consumer article by the locking mechanism.

13. A system as recited in claim 12, wherein the security and inventory management tag is provided with advertising indicia corresponding to the consumer article.

14. A system as recited in claim 12, wherein the housing is one of clear, transparent, translucent, colored or partially colored or combinations thereof.

15. A system as recited in claim 12, wherein the radio frequency device operates in one of UHF, HF or LF frequencies.

16. A system as recited in claim 12, wherein the top portion is ultrasonically bonded to the bottom portion.

17. A system as recited in claim 12, wherein the consumer article is an apparel item.

18. A security and inventory management device for use with apparel items, comprising;
a transparent housing having a cavity formed therein, the housing having a base portion and a top portion, first and second longitudinally extending side edges that slope upwardly and inwardly from the base portion toward a central area of the top portion, a first end and a second end, with the first end having an edge that is generally curvilinear and the second end tapered from the first end, the first end having a bulbous element extending upwardly from the top portion and having an opening centrally disposed within the bulbous element and the base portion having a cylindrical aperture extending upwardly from the base portion and disposed substantially beneath the bulbous element;
a radio frequency device disposed within the cavity, the radio frequency device including an inlay having a substrate with an antenna and an integrated circuit coupled to the antenna the antenna and integrated circuit laminated in the substrate and operating in a UHF frequency; and
a locking mechanism placed in the first end and extending vertically into the bulbous element and upwardly to the opening of the bulbous opening and disposed at least partially in the cylindrical aperture of the base portion and a pin disposed at least partially through the opening the bulbous element.

19. A device as provided in claim 18, wherein the security and inventory management device includes advertising indicia.

20. A device as provided in claim 18, wherein the top portion is ultrasonically along the bottom portion along each of the first and second longitudinally extending sides.
